(19) United States
(12) Patent Application Publication
(10) Pub. No.: US 2025/0365835 A1
(43) Pub. Date: Nov. 27, 2025

(54) INFORMATION PROCESSING SYSTEM, INFORMATION PROCESSING METHOD, AND NON-TRANSITORY RECORDING MEDIUM

(71) Applicant: NEC Corporation, Tokyo (JP)

(72) Inventor: Naoya TSUJI, Tokyo (JP)

(73) Assignee: NEC Corporation, Tokyo (JP)

(21) Appl. No.: 19/206,358

(22) Filed: May 13, 2025

(30) Foreign Application Priority Data
May 21, 2024 (JP) 2024-082641

(51) Int. Cl. H05B 47/115

(52) U.S. Cl. CPC H05B 47/115

(57) ABSTRACT

An information processing system included: at least one memory that is configured to store instructions; and at least one processor that is configured to execute the instructions to: control lighting apparatuses to emit light in at least one of the following modes: a first mode in which light is emitted to at least a first target in case the first target is located in a predetermined area; and a second mode in which light is emitted at least to a second target in case the second target is located in the predetermined area; and acquire at least one of biometric information of the first target to which light is emitted by the lighting apparatuses and biometric information of the second target to which light is emitted by the lighting apparatuses.

### INCORPORATION BY REFERENCE

This application is based upon and claims the benefit of priority from Japanese Patent Application No. 2024-082641, filed on May 21, 2024, the disclosure of which is incorporated herein in its entirety by reference.

### TECHNICAL FIELD

This disclosure relates to the technical fields of information processing system, information processing methods, and recording media.

### BACKGROUND ART

Apparatus that emits light on a person is known. For example, the Patent Literature (JP 2015-134678 A) discloses an apparatus that emits light by adjusting the light intensity based on the position of the person.

### SUMMARY

It is an example object of this disclosure to provide an information processing system, an information processing method, and a recording medium for emitting light on a target appropriately.

An information processing system according to an example aspect includes at least one memory that is configured to store instructions; and at least one processor that is configured to execute the instructions to: control lighting apparatuses to emit light in at least one of the following modes: a first mode in which light is emitted to at least a first target in case the first target is located in a predetermined area; and a second mode in which light is emitted at least to a second target in case the second target is located in the predetermined area; and acquire at least one of biometric information of the first target to which light is emitted by the lighting apparatuses and biometric information of the second target to which light is emitted by the lighting apparatuses.

An information processing method according to an example aspect includes: controlling lighting apparatuses to emit light in at least one of the following modes: a first mode in which light is emitted to at least a first target in case the first target is located in a predetermined area; and a second mode in which light is emitted at least to a second target in case the second target is located in the predetermined area; and acquiring at least one of biometric information of the first target to which light is emitted by the lighting apparatuses and biometric information of the second target to which light is emitted by the lighting apparatuses.

A recording medium according to an example aspect is a recording medium on which a computer program that allows a computer to execute an information processing method is recorded, the information processing method including: controlling lighting apparatuses to emit light in at least one of the following modes: a first mode in which light is emitted to at least a first target in case the first target is located in a predetermined area; and a second mode in which light is emitted at least to a second target in case the second target is located in the predetermined area; and acquiring at least one of biometric information of the first target to which light is emitted by the lighting apparatuses and biometric information of the second target to which light is emitted by the lighting apparatuses.

### BRIEF DESCRIPTION OF THE DRAWINGS

FIG. 1 is a block diagram illustrating an example of a configuration of an information processing apparatus according to this disclosure;

FIG. 2 is a flowchart illustrating an example of a flow of operation of the information processing apparatus according to this disclosure;

FIG. 3A and FIG. 3B are schematic diagrams showing an overview of an information processing operation in the information processing apparatus according to this disclosure;

FIG. 4 is an overview of an information processing system according to this disclosure;

FIG. 5 is a block diagram illustrating an example of a configuration of the information processing apparatus according to this disclosure;

FIG. 6 is a flowchart illustrating an example of a flow of operation of the information processing apparatus according to this disclosure;

FIG. 7 is schematic diagram showing an overview of an information processing operation in the information processing apparatus according to this disclosure;

FIG. 8A, FIG. 8B and FIG. 8C are schematic diagram showing an overview of an information processing operation in the information processing apparatus according to this disclosure;

FIG. 9 is an overview of an information processing system according to this disclosure;

FIG. 10 is a block diagram illustrating an example of a configuration of the information processing apparatus according to this disclosure;

FIG. 11 is schematic diagrams showing an overview of an information processing operation in the information processing apparatus according to this disclosure;

FIG. 12 is schematic diagram showing an overview of an information processing operation in the information processing apparatus according to this disclosure;

FIG. 13A, FIG. 13B, FIG. 13C and FIG. 13D are schematic diagrams showing an overview of an information processing operation in the information processing apparatus according to this disclosure;

FIG. 14A and FIG. 14B are schematic diagrams showing an overview of a modified example of a lighting apparatus according to his disclosure;

FIG. 15 is an overview of an information processing system according to this disclosure;

FIG. 16 is a block diagram illustrating an example of a configuration of the information processing apparatus according to this disclosure;

FIG. 17A, FIG. 17B and FIG. 17C are schematic diagrams showing an overview of an information processing operation in the information processing apparatus according to this disclosure.

### EXAMPLE EMBODIMENTS

The following describes embodiments of an information processing apparatus, an information processing system, an information processing method, and a recording medium with reference to the drawings.

### 1: First Example Embodiment

A first embodiment of an information processing apparatus, an information processing system, an information processing method, and a recording medium is described below. The first embodiment of the information processing apparatus, the information processing system, the information processing method, and the recording medium is described below, using an information processing apparatus 1 in this disclosure.

This disclosure relates to the technical fields of an information processing apparatus, an information processing system, an information processing method, and a recording medium.

Apparatus that emits light on a person is known. For example, the Patent Literature (JP 2015-134678 A) discloses an apparatus that emits light by adjusting the light intensity based on the position of the person.

This disclosure is to provide an information processing apparatus, an information processing system, an information processing method, and a recording medium for emitting light on a target appropriately.

The following describes embodiments of an information processing apparatus, an information processing system, an information processing method, and a recording medium with reference to the drawings.

A first embodiment of an information processing apparatus, an information processing system, an information processing method, and a recording medium is described below. The first embodiment of the information processing apparatus, the information processing system, the information processing method, and the recording medium is described below, using an information processing apparatus 1 in this disclosure.

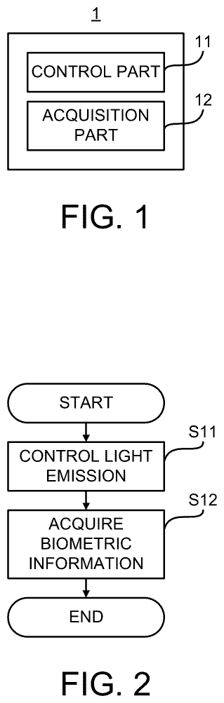

Referring to FIG. 1 and FIG. 2, this disclosure will be explained. As shown in FIG. 1, the information processing apparatus 1 comprises a control part 11 and an acquisition part 12. The operation of the information processing apparatus 1 will be explained with reference to the flowchart in FIG. 2.

As shown in FIG. 2, the control part 11 controls lighting apparatuses to emit light to at least one of a first mode and a second mode (step S11). The first mode is a mode in which light is emitted at least to a first target in case the moving first target is located at a predetermined area. The second mode is a mode in which light is emitted at least to a second target in case the second target is located at the predetermined area.

The first target and the second target may be targets whose biometric information is acquired. The biometric information is information about the physical characteristics of the target. Examples of the biometric information include at least one of the following: a facial image including a face of the target, an iris image including an iris of the target, a fingerprint pattern of the target, a palm print pattern of the target, a pattern of veins in fingers and palms of the targe, voice information including a voice of the target, and sound information including an acoustic radiation from ear of the target.

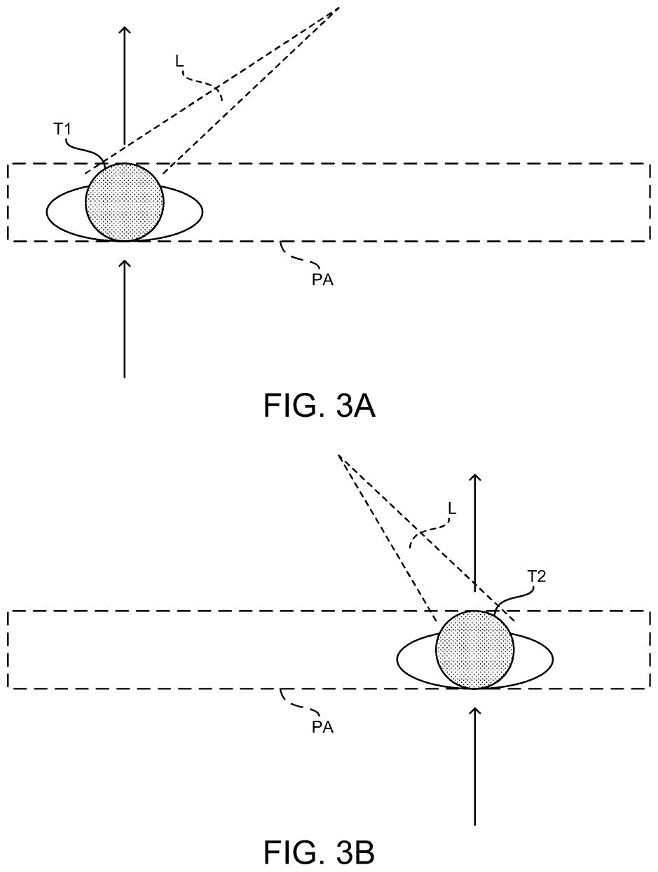

FIG. 3A illustrates an example of emitting light with the first mode. FIG. 3A shows an example of case a moving first target T1 is positioned at a predetermined area PA and light Lis emitted on the first target T1 positioned at the predetermined area PA.

FIG. 3B shows an example of emitting light with the second mode. FIG. 3B shows an example of case a moving second target T2 is positioned at the predetermined area PA and light L is emitted on the second target T2 positioned at the predetermined area PA.

The acquisition part 12 acquires at least one of the biometric information of the first target emitted by the lighting apparatus and the biometric information of the second target emitted by the lighting apparatus (step S12). For example, the acquisition part 12 may acquire at least one of the biometric information of the first target T1 in the case illustrated in FIG. 3A and the biometric information of the second target T2 in the case illustrated in FIG. 3B. In other words, the acquisition part 12 may acquire at least one of the biometric information of the first target T1 located in the predetermined area PA and the biometric information of the second target T2 located in the predetermined area PA.

In case the biometric information is acquired by imaging, the predetermined area may be an area suitable for imaging. For example, in case the target is located in the predetermined area, it may be possible to acquire an image with the target in focus.

In this way, in the information processing apparatus 1, performs an information processing method including controlling lighting apparatuses to emit light in at least one of the following modes: a first mode in which light is emitted to at least a first target in case the first target is located in a predetermined area; and a second mode in which light is emitted at least to a second target in case the second target is located in the predetermined area; and acquiring at least one of biometric information of the first target to which light is emitted by the lighting apparatuses and biometric information of the second target to which light is emitted by the lighting apparatuses.

The information processing apparatus 1 described above may be achieved by a computer reading a computer program recorded on a recording medium. In this case, the computer program causes the computer to execute the information processing method including controlling lighting apparatuses to emit light in at least one of the following modes: a first mode in which light is emitted to at least a first target in case the first target is located in a predetermined area; and a second mode in which light is emitted at least to a second target in case the second target is located in the predetermined area; and acquiring at least one of biometric information of the first target to which light is emitted by the lighting apparatuses and biometric information of the second target to which light is emitted by the lighting apparatuses.

### [Technical Effect]

The information processing apparatus 1 according to this disclosure can emit light on the target located in the predetermined area and acquire the biometric information of the target located in the predetermined area.

### 2: Second Example Embodiment

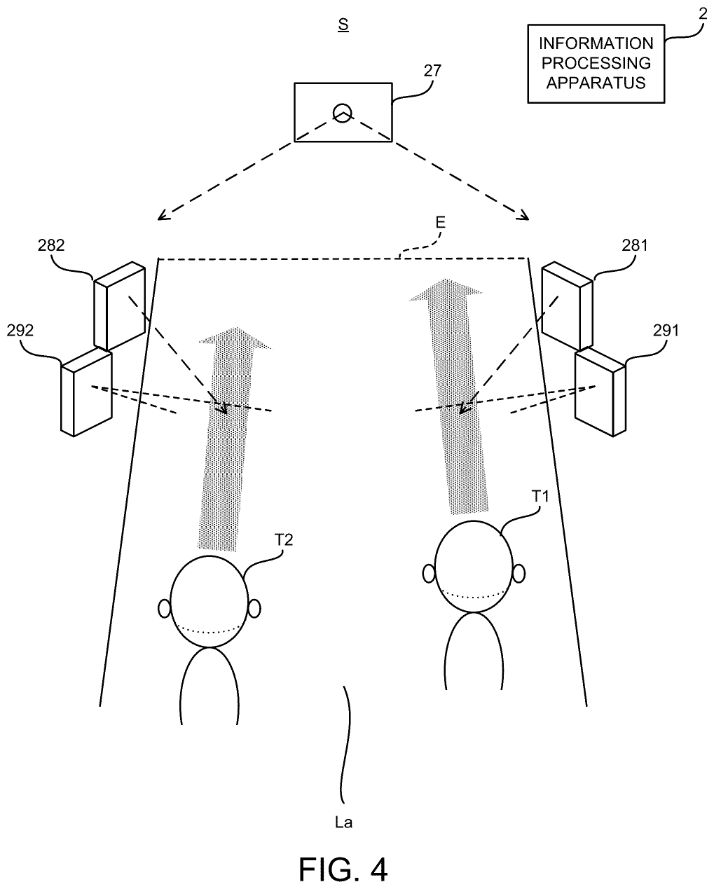

A second embodiment of the information processing apparatus, the information processing system, the information processing method and the recording medium is explained with reference to FIG. 4 to FIG. 8. In the following, the second embodiment of the information processing apparatus, the information processing system, the information processing method and the recording medium will be explained using an information processing system S. For the second embodiment, explanations that overlap with the above-mentioned first embodiment will be omitted as appropriate.

### [2-1: Configuration of the Information Processing System S]

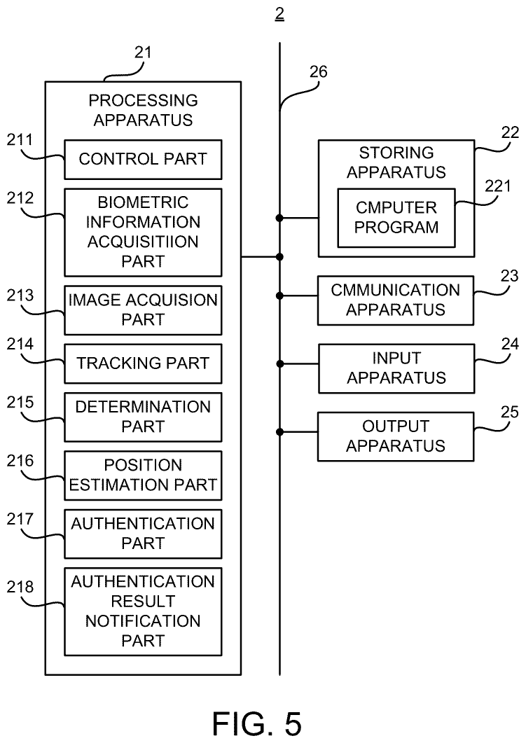

FIG. 4 is an overview diagram showing an overview of the information processing system S according to this disclosure. FIG. 5 is a block diagram showing the configuration of an information processing apparatus 2 according to this disclosure.

As shown in FIG. 4, the information processing system S is applied to a location where the first target T1 and the second target T2 can move side by side. This location where the first target T1 and the second target T2 can move side by side is referred to as a lane La. The locations that the first target T1 and the second target T2 are heading may be located beyond the direction of the arrow shown in FIG. 4. The first target T1 and the second target T2 may be guided to move in the direction of the arrow shown in FIG. 4. The first target T1 and the second target T2 move in a longitudinal direction of the lane La. The direction in which the first target T1 and the second target T2 move may be referred to as “moving direction”. In the lane La, the first target T1 and the second target T2 may move side by side in a direction other than “the moving direction”. In the lane La, the first target T1 and the second target T2 may be able to move side by side in a lateral direction of the lane La (referred to as “a width direction of the lane La”). The width direction of the lane La may be about twice the width of the passageway that an average adult can move through. In other words, the lane La may have a width that allows two targets to move in line in a direction different from the moving direction.

The information processing system S may be applied to determining whether or not to allow entry into a restricted area and controlling entry into the restricted area. The restricted area may be an area that the target that has successfully authenticated can enter. The restricted area may be an area beyond an endpoint E of the lane La in the moving direction, as illustrated in FIG. 4. Therefore, the information processing system S may be configured to authenticate the target within the lane L behind the endpoint E of the lane L in the moving direction. The target may be a target for a biometric authentication (i.e., authentication using the biometric information). The information processing system S may be configured to authenticate the target using biometric authentication.

As described above, the biometric information is information about the physical characteristics of the target. Examples of the biometric information include at least one of the following: a facial image including a face of the target, an iris image including an iris of the target, a fingerprint pattern of the target, a palm print pattern of the target, a vein pattern of a finger and a palm of the target, voice information including a voice of the target, and sound information including the acoustic radiation from the ear of the target. Examples of the authentication using the biometric information include at least one of a face authentication, an iris authentication, a fingerprint authentication, a palm print authentication, a vein authentication, a voiceprint authentication, and an ear acoustic authentication. The target may be authenticated using one type of biometric information. In addition, the target may be authenticated using a combination of multiple types of biometric information. In other words, the target may be a target for multi-modal biometric authentication.

As shown in FIG. 4, the information processing system S may be equipped with a camera 27, a first camera 281, a second camera 282, a first lighting apparatus 291, a second lighting apparatus 292, and the information processing apparatus 2. In case explaining the first camera 281 and the second camera 282 without distinguishing between them, they may be referred to as an iris camera 28. The camera 27 may be a camera capable of imaging light in the visible light wavelength range (so-called visible light camera). Alternatively, the camera 27 may be a camera capable of imaging light in the near-infrared wavelength range (so-called near-infrared camera). The image captured by the camera 27 may also include moving images. The iris camera 28 may be a camera capable of imaging light in the near-infrared wavelength range (so-called near-infrared camera). Alternatively, the iris camera 28 may be cameras capable of capturing visible light (so-called visible light cameras). The images captured by the iris camera 28 may include moving images. The first lighting apparatus 291 and the second lighting apparatus 292 may be capable of emitting light in the near-infrared wavelength range. Alternatively, the first lighting apparatus 291 and the second lighting apparatus 292 may be capable of emitting light in the visible light wavelength range.

The camera 27 captures an image of a space in which the first target T1 and the second target T2 can move side by side. The camera 27 acquires an image including the first target T1 and the second target T2 by capturing the image. The camera 27 may image the space in which the first target T1 and the second target T2 can move side by side in the width direction of the lane La. The camera 27 may be provided at a location from which the first target T1 and the second target T2 moving side by side can be viewed, as shown in FIG. 4. The camera 27 may be provided to image an area in which the first target T1 and the second target T2 can move side by side. The camera 27 may be provided to image the area in which at least one of the first camera 281 and the second camera 282 can be imaged. The camera 27 may be provided to image the area in which at least one of the first lighting apparatus 291 and the second lighting apparatus 292 can emit light.

The first camera 281 may be provided at one end of a direction that is different from the moving direction. For example, the first camera 281 may be provided at one end of a horizontal direction perpendicular to the moving direction. In other words, the first camera 281 may be provided at one end side of the width direction of the lane La. The second camera 282 may be provided at other end of a direction that is different from the moving direction. For example, the second camera 282 may be provided at other end of the horizontal direction perpendicular to the moving direction. In other words, the second camera 282 may be provided at other end side of the width direction of the lane La. It may also be said that there is a space between the first camera 281 and the second camera 282 where the first target T1 and the second target T2 can move side by side.

The first camera 281 may image the iris of the target moving on an one side of the width direction of the lane La from the one end side of the width direction of the lane La. In the case of the example in FIG. 4, the first camera 281 may be provided at the right side of the lane La as seen from the target (on the left side of the lane La as seen from the camera 27). In the case of the example in FIG. 4, the first camera 281 may image the iris of the first target T1 moving on the right side of the lane La as seen from the target.

The second camera 282 may image the iris of the target moving on an other side of the width direction of the lane La from the other end side of the width direction of the lane La. In the case of the example shown in FIG. 4, the second camera 282 may be provided at the left side of the lane La as seen from the target (on the right side of the lane La as seen from the camera 27). In the case of the example shown in FIG. 4, the second camera 282 may image the iris of the second target T2 moving on the left side of the lane La as seen from the target.

The first lighting apparatus 291 may be provided at the one end of a direction different from the moving direction. For example, the first lighting apparatus 291 may be provided at the one end of a horizontal direction perpendicular to the moving direction. In other words, the first lighting apparatus 291 may be provided at the one end side of the width direction of the lane La. The second lighting apparatus 292 may be provided at the other end in the direction different from the moving direction. For example, the second lighting apparatus 292 may be provided at the horizontal direction perpendicular to the moving direction. In other words, the second lighting apparatus 292 may be provided at the other end side of the width direction of the lane La. It may also be said that there is a space between the first lighting apparatus 291 and the second lighting apparatus 292 where the first target T1 and the second target T2 can move side by side.

The first lighting apparatus 291 may emit light to an eye area including the iris of the target moving the lane La from the one end side of the width direction of the lane La. In the case of the example in FIG. 4, the first lighting apparatus 291 may be provided at the right side of the lane La as seen from the target (on the left side of the lane La as seen from the camera 27). In the case of the example in FIG. 4, the first lighting apparatus 291 may emit light to the eye area including the iris of the target moving the lane La from the right side of the lane La as seen by the target. The first lighting apparatus 291 may emit light to at least the right eye area of the target moving the lane La from the right side of the lane La as seen by the target.

The second lighting apparatus 292 may emit light to the eye area including the iris of the target moving the lane La from the other end side of the width direction of the lane La. In the case of the example in FIG. 4, the second lighting apparatus 292 may be provided at the left side of the lane La as seen from the target (on the right side of the lane La as seen from the camera 27). In the case of the example in FIG. 4, the second lighting apparatus 292 may emit light to the eye area including the iris of the target moving the lane La from the left side of the lane La as seen from the target. The second lighting apparatus 292 may emit light to at least the left eye area of the target moving the lane La from the left side of the lane La as seen from the target.

FIG. 4 shows an example where the camera 27 is provided at a location where the first target T1 and the second target T2 can be viewed from above, but the location where the camera 27 is provided is not limited to this. The camera 27 may be provided at a vicinity of at least one of the first camera 281 and the second camera 282. For example, the camera 27 may be provided at the same housing as the first camera 281. In addition, the camera 27 may be provided at the same housing as the second camera 282. The camera 27 may be provided at plural. That is, the camera 27 may be provided at a vicinity of the first camera 281 and in a vicinity of the second camera 282.

The camera 27 may capture images used to track the target. In addition, the camera 27 may capture images to determine a camera that captures the iris of the target. Furthermore, the camera 27 may capture images to determine the position of the iris of the target.

As shown in FIG. 5, the information processing apparatus 2 is provided with a processing apparatus 21, a storing apparatus 22, a communication apparatus 23, an input apparatus 24 and an output apparatus 25. The processing apparatus 21, the storing apparatus 22, the communication apparatus 23, the input apparatus 24 and the output apparatus 25 may be connected via a data bus 26. The processing apparatus 21, for example, may be a CPU (central processing unit), GPU (Graphics Processing Unit), FPGA (Field Programmable Gate Array), TPU (Tensor Processing Unit), and quantum processor, at least one of which may be included.

The storing apparatus 22 may include at least one of RAM (Random Access Memory), ROM (Read Only Memory), hard disk apparatus, optical magnetic disk apparatus, SSD (Solid State Drive), and optical disk array. In other words, the storing apparatus 22 may include non-temporary storage media. The storing apparatus 22 is capable of storing desired data. For example, the storing apparatus 22 may temporarily store a computer program 221 executed by the processing apparatus 21. The storing apparatus 22 may temporarily store data temporarily used by the processing apparatus 21 in case the processing apparatus 21 is executing the computer program 221.

The communication apparatus 23 may be able to communicate with apparatus external to the information processing apparatus 2. Furthermore, the communication apparatus 23 may be able to communicate by wired or wireless communication. The information processing apparatus 2 is able to communicate with the camera 27, the first camera 281, the second camera 282, the first lighting apparatus 291, and the second lighting apparatus 292 included in the information processing system S. The information processing apparatus 2 may communicate with the camera 27, the first camera 281, the second camera 282, the first lighting apparatus 291, and the second lighting apparatus 292 via the communication apparatus 23. The information processing apparatus 2 and the camera 27, the first camera 281, the second camera 282, the first lighting apparatus 291, and the second lighting apparatus 292 may communicate wirelessly or via a wired connection.

The input apparatus 24 is an apparatus that can accept information input from the outside for the information processing apparatus 2. The input apparatus 24 may include an operating apparatus (e.g., keyboard, mouse, touch panel, etc.) that can be operated by the user of the information processing apparatus 2. The input apparatus 24 may include a recording medium reader that can read information recorded on a recording medium that can be attached to or detached from the information processing apparatus 2, such as a USB (Universal Serial Bus) memory. In addition, in case information is input to the information processing apparatus 2 via the communication apparatus 23 (in other words, when the information processing apparatus 2 acquires information via the communication apparatus 23), the communication apparatus 23 may function as an input apparatus.

The output apparatus 25 is an apparatus capable of outputting information to the outside of the information processing apparatus 2. The output apparatus 25 may output visual information such as characters and images, auditory information such as sound, or tactile information such as vibration. The output apparatus 25 may include, for example, at least one of a display, a speaker, a printer, and a vibration motor. The output apparatus 25 may be able to output information to a removable recording medium, such as a USB memory stick, etc. In addition, in case the information processing apparatus 2 outputs information via the communication apparatus 23, the communication apparatus 23 may function as an output apparatus.

In this embodiment, the processing apparatus 21 has a control part 211, a biometric information acquisition part 212, an image acquisition part 213, a tracking part 214, a determination part 215, a position estimation part 216, an authentication part 217, and an authentication result notification part 218 as function blocks that are logically realized or processing circuits that are physically realized. “The control part 211” and ‘the biometric information acquisition part 212’ are structural elements that correspond to ‘the control part 11’ and ‘the acquisition part 12’ in the first embodiment described above, respectively.

In addition, at least one of the control part 211, the biometric information acquisition part 212, the image acquisition part 213, the tracking part 214, the determination part 215, the position estimation part 216, the authentication part 217, and the authentication result notification part 218 may be realized in a form that mixes logical functional blocks and physical processing circuits (i.e., hardware). In case at least one of the control part 211, the biometric information acquisition part 212, the image acquisition part 213, the tracking part 214, the determination part 215, the position estimation part 216, the authentication part 217, and the authentication result notification part 218 is a functional block, at least one of the control part 211, the biometric information acquisition part 212, the image acquisition part 213, the tracking part 214, the determination part 215, the position estimation part 216, the authentication part 217, and the authentication result notification part 218 may be realized by the processing apparatus 21 executing a predetermined computer program.

The processing apparatus 21 may acquire (in other words, read) the computer program 221 from the storing apparatus 22 as described above. The processing apparatus 21 may read the predetermined computer program 221 stored on a computer-readable and non-temporary recording medium using a non-illustrated recording medium reader provided by the information processing apparatus 2. The processing apparatus 21 may acquire the above-mentioned predetermined computer program 221 from an unillustrated apparatus external to the information processing apparatus 2 via the communication apparatus 23 (in other words, it may download or read it). As a recording medium for recording the above-mentioned predetermined computer program 221 executed by the processing apparatus 21, at least one of an optical disk, a magnetic medium, an optical magnetic disk, a semiconductor memory, and any other medium capable of storing a program may be used.

### [2-2: Information Processing Method Executed by the Information Processing Apparatus 2]

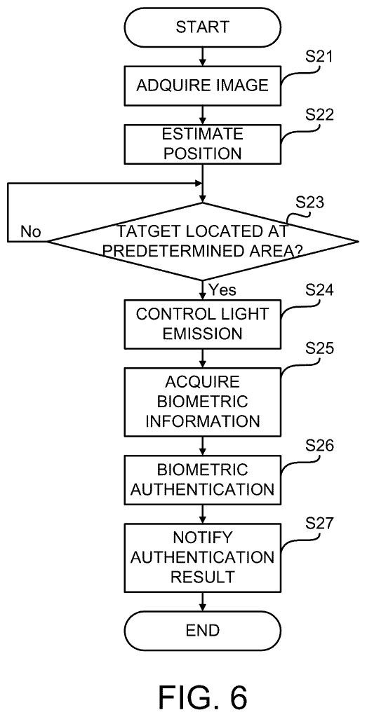

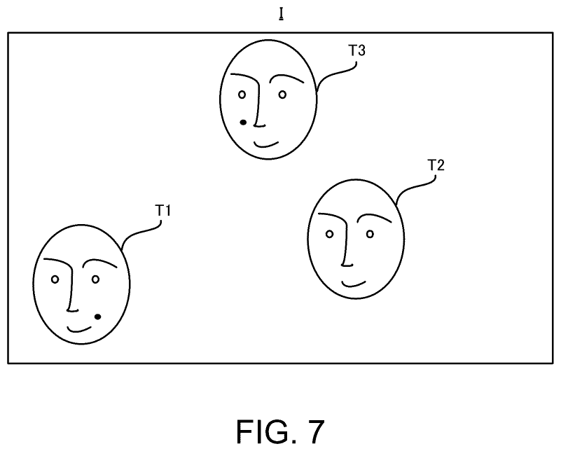

The information processing apparatus 2 is configured as an apparatus for acquiring an iris image by sequentially emitting light on the target that moves in the moving direction and for performing authentication (iris authentication) using the iris image. The information processing method performed by the information processing apparatus 2 is explained with reference to FIG. 6 to FIG. 8C. FIG. 6 is a flowchart showing the flow of the information processing method performed by the information processing apparatus 2. FIG. 7 to IG. 8C are overview diagrams showing an overview of the information processing method performed by the information processing apparatus 2.

As shown in FIG. 6, the image acquisition part 213 acquires an image from the camera 27 (step S21). The camera 27 may be provided so as to be able to capture an image of the lane L from the position where the first lighting apparatus 291 and the second lighting apparatus 292 are provided to a predetermined position behind in the moving direction (this area is referred to as “a tracking area”). In this case, the image acquisition part 213 may be said to acquire an image of the tracking area. The camera 27 may be provided at a height of, for example, 2.5 meters. If the camera 27 is provided at a height higher than the average human height, the image captured by the camera 27 is likely to include a head area and an upper body area of the target. The head area and the upper body area may be suitable areas for tracking the target. In addition, in case there are a plurality of the camera 27, the image acquisition part 213 may acquire images from the plurality of the camera 27.

FIG. 7 shows an example of an image I acquired from the camera 27. FIG. 7 shows an example of case there are three targets in the tracking area. The tracking part 214 tracks each of the targets included in the image. The tracking part 214 tracks each of the targets in the tracking area based on the image. In the case of the example in FIG. 7, the tracking part 214 may track each of the first target T1, the second target T2, and a third target T3.

The image used by the tracking part 214 for tracking may be a single frame of a video. In this case, the image acquisition part 213 may sequentially acquire multiple frames that make up the video as images. The tracking part 214 may perform tracking by matching a same target between a past frame and a current frame. For example, the tracking part 214 may perform tracking by determining the position of the head area in the image. The tracking part 214 may match the same target in different frames based on the position of the head area in the image. The tracking part 214 may perform tracking by determining the identity of the image pattern of the head area, for example. The tracking part 214 may also track by determining the similarity of feature information extracted from images of the head area.

In case there are the plurality of the camera 27, the tracking part 214 may track each the target included in each of the multiple images captured by the multiple the camera 27. For example, the tracking part 214 may integrate the target included in each of the multiple images by extracting and matching feature parts of the target. The feature parts of the target may correspond to, for example, the head area of the target, the upper body area of the target, or the clothes worn by the target. The feature parts of the target may be a part that can distinguish between individuals. The feature parts of the target may not be parts that can identify individuals.

The determination part 215 may identify two targets from targets included in the image. The determination part 215 may identify the two targets located in the foreground in the image, among the targets for which it has not been determined whether they will be imaged in the first camera 281 or the second camera 282.

Of three targets shown in FIG. 7, it is assumed that it has not yet been determined whether the first target T1, the second target T2, and the third target T3 will be captured by the first camera 281 or the second camera 282. In this case, the determination part 215 may specify two targets (i.e. the first target T1 and the second target T2) that are in foreground in the image I. In case there are less than two targets that have not yet been determined to be captured by either the first camera 281 or the second camera 282, the determination part 215 may specify less than two targets.

The determination part 215 may determine one of the two targets to be the target to be imaged by the first camera 281 based on the image, and other of the two targets to be the target to be imaged by the second camera 282. The determination part 215 may determine the target to be imaged by the first camera 281 and the target to be imaged by the second camera 282 based on at least one of a positional relationship between the first target and the second target included in the image and a distance from each of the first target and the second target to the camera 27. In the case of the example in FIG. 7, the determination part 215 may determine that the first target T1, which is located to the left of the image I, is the first target for which the iris is imaged by the first camera 281, and that the second target T2, which is located to the right of the image I, is the second target for which the iris is imaged by the second camera 282. Alternatively, the determination part 215 may divide the image along a vertical line and determine that the first camera 281 will capture an one target included in one of divided images, and that the second camera 282 will capture an other target included in other of the divided images. The determination part 215 may divide the image vertically into two images, so that an one image includes the one target and an other image includes the other target.

In case the image includes one target, the determination part 215 may divide the image into left and right at the center, and determine that the first camera 281 will capture the target in case the target is included in the left image, and that the second camera 282 will capture the target in case the target is included in the right image.

Alternatively, the determination part 215 may determine that the first camera 281 provided at the one end of the lane L captures an image of the target in case the line of sight of the target is directed toward the one end of the lane L from the center of the lane L. The determination part 215 may also determine that the second camera 282 provided at the other end of the lane L captures an image of the target in case the line of sight of the target is directed toward the other end of the lane L from the center of the lane L.

In addition, in case the tracking part 214 detects at least one of the target that is in the same position for a predetermined period of time or more and that is of the same size for a predetermined period of time or more in the image, the tracking part 214 may determine that the corresponding target is standing still. The information processing apparatus 2 may have a mechanism that outputs information to the relevant targets to alert them that they are standing still, and may output information to alert them that they are standing still. In addition, the camera 27 may be set at a height where the target cannot look into the camera lens, and this may be used to suppress the target from standing still.

The position estimation part 216 estimates the position of the moving target in case the target is located at the predetermined area (step S22). The position of the moving first target T1 in case the target T1 is located at the predetermined area PA is referred to as a first position P1. The position estimation part 216 may estimate the first position P1. In addition, the position of the moving second target T2 in case the second target T2 is located at the predetermined area PA is referred to as a second position P2. The position estimation part 216 may be estimated the second position P2.

The tracking part 214 determines whether the moving target is located at the predetermined area (step S23). The predetermined area may be, for example, an area that is a predetermined distance away from a position in the moving direction where at least one of the first lighting apparatus 291 and the second lighting apparatus 292 is provided. The predetermined area may be an area in the lane La. In case the moving target is located in the predetermined area (step S23: Yes), the control part 211 emits light on the target located in the predetermined area (step S24).

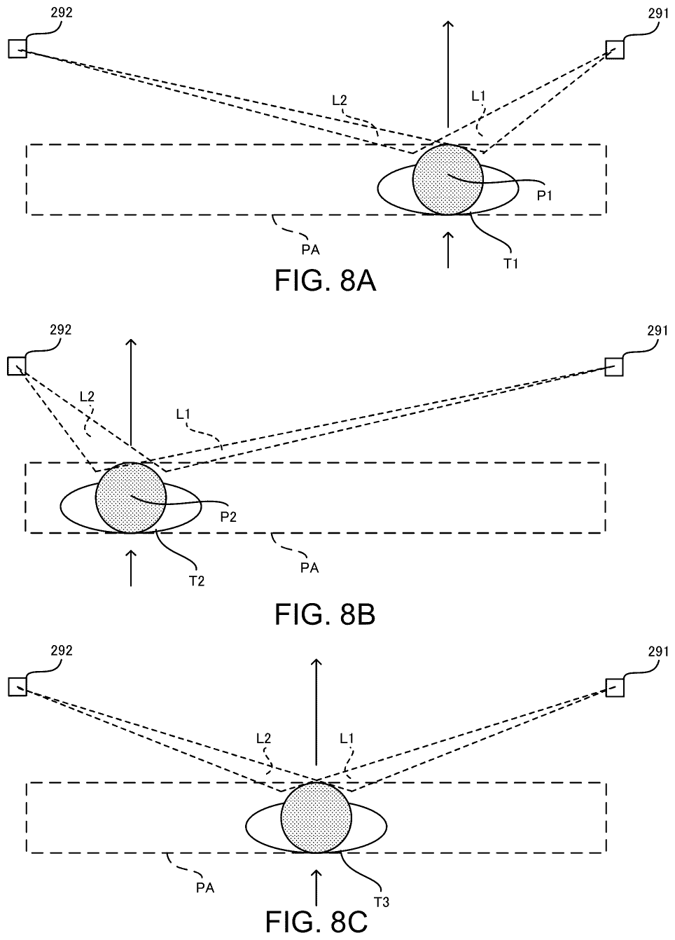

FIG. 8A illustrates the case where the moving first target T1 is located at the predetermined area PA. The control part 211 may control the first lighting apparatus 291 to emit light L1 to the first position P1, and may control the second lighting apparatus 292 to emit light L2 to the first position P1. FIG. 8A illustrates the case where the target is moving on one side of the center of an alignment direction. The alignment direction is a direction different from the moving direction of the first target T1 and the second target T2. The alignment direction may be a longitudinal direction of the predetermined area PA.

In the case of the example in FIG. 8A, the control part 211 may control the light L2, which is emitted by the second lighting apparatus 292, to be more than the light L1, which is emitted by the first lighting apparatus 291. In other words, the control part 211 may control the light emitted by the second lighting apparatus 292 on the other end of the lane La to be greater than the light emitted by the first lighting apparatus 291 on the one end of the lane La. Specifically, the light emitted by the second lighting apparatus 292 on the other end of the lane La may control to be stronger than the light emitted by the first lighting apparatus 291 on the one end of the lane La. In addition, the control part 211 may control the light emitted by the second lighting apparatus 292 located at the other end of the lane La to have a longer emission time than the light emitted by the first lighting apparatus 291 located at the one end of the lane La.

The control part 211 may control the brightness of the target lighted to be similar regardless of where the target is located in the predetermined area PA. In other words, the control part 211 may controls the brightness of the image captured by the first camera 281 and the image captured by the second camera 282 to be similar. In addition, the control part 211 may control so that there is no difference in brightness between left side of the target and right side of the target.

The light that illuminates the target depends on the distance between the target and the lighting apparatus. Therefore, in case the lighting apparatus emits the target with the same amount of light, the brightness of the target that is relatively far from the lighting apparatus will be darker than the brightness of the target that is relatively close to the lighting apparatus. Therefore, the control part 211 may control the amount of light emitted by the first lighting apparatus 291 and the second lighting apparatus 292 according to the position of the target in the predetermined area PA.

FIG. 8B shows an example where the moving second target T2 is positioned at the predetermined area PA. As shown in FIG. 8A and FIG. 8B, the first position P1 and the second position P2 are different positions in the alignment direction.

The control part 211 may control the first lighting apparatus 291 to emit the light L1 at the second position P2, and may control the second lighting apparatus 292 to emit the light L2 at the second position P2. FIG. 8B shows an example where the target is moving on the other side of the center of the alignment direction. In the case shown in FIG. 8B, the control part 211 may control the light L1 emitted by the first lighting apparatus 291 to be greater than the light L2 emitted by the second lighting apparatus 292. In other words, the control part 211 may control the light emitted by the first lighting apparatus 291 located at the one end of the lane La to be more than the light emitted by the second lighting apparatus 292 located at the other end of the lane La.

The control part 211 may control the light L1 emitted by the first lighting apparatus 291 to be greater in the case of FIG. 8B than in the case of FIG. 8A. In addition, the control part 211 may control the light L2 emitted by the second lighting apparatus 292 to be greater in the case of FIG. 8A than in the case of FIG. 8B.

FIG. 8C shows an example where the moving third target T3 is located at the predetermined area PA. The control part 211 may control the first lighting apparatus 291 to emit the light L1 to the third target T3, and may also control the second lighting apparatus 292 to emit the light L2 to the third target T3. FIG. 8C shows an example where the target is moving on the center of the alignment direction. In the case illustrated in FIG. 8C, the control part 211 may control the light intensity of the light L1 emitted by the first lighting apparatus 291 and the light L2 emitted by the second lighting apparatus 292 to be equal. The control part 211 may control the amount of the light L1 emitted by the first lighting apparatus 291 to be greater in the case illustrated in FIG. 8C than in the case illustrated in FIG. 8A. In addition, the control part 211 the amount of the light L1 emitted by the first lighting apparatus 291 to be greater in the case illustrated in FIG. 8B than in the case illustrated in FIG. 8C. In addition, the control part 211 may control the amount of the light L2 emitted by the second lighting apparatus 292 to be greater in the case illustrated in FIG. 8A than in the case illustrated in FIG. 8C. In addition, the control part 211 the amount of the light L2 emitted by the second lighting apparatus 292 to be greater in the case illustrated in FIG. 8C than in the case illustrated in FIG. 8B. Furthermore, the mode in which light is emitted on at least the third target in case the moving third target is located at the predetermined area may be referred to as the third mode. In this case, the control part 211 may control the lighting apparatus to emit light in at least one of the first mode, the second mode, and the third mode.

In addition, the control part 211 may control the first lighting apparatus 291 and the second lighting apparatus 292 so that the shadow of other target does not occur on the first target and the second target. The other target may be a target for which the biometric information has already been acquired. The control part 211 may control the first lighting apparatus 291 and the second lighting apparatus 292 based on the position and moving speed of the other target. For example, the control part 211 may change the direction of the light emitted by the first lighting apparatus 291 and the second lighting apparatus 292 based on the position and moving speed of the other target. In addition, in FIG. 4, the first camera 281 and the first lighting apparatus 291 are adjacent, and the second camera 282 and the second lighting apparatus 292 are adjacent, but in order to prevent the shadow of the other target moving in front of the target is cast on the target, the first lighting apparatus 291 may be provided away from the first camera 281, and the second lighting apparatus 292 may be provided away from the second camera 282.

The first camera 281 may capture an image of the iris of the first target T1 who is emitted by the first lighting apparatus 291 and the second lighting apparatus 292, and acquire an iris image 1 that includes the iris of the first target T1. In addition, the second camera 282 may capture an image of the iris of the second target T2 who is emitted by the first lighting apparatus 291 and the second lighting apparatus 292, and acquire an iris image 2, which includes the iris of the second target T2. In case the iris image includes an image area that does not satisfy a predetermined brightness, the iris camera may perform image processing to brighten the image area that does not satisfy the predetermined brightness. The authentication part 217 acquires iris image 1 from the first camera 281 and iris image 2 from the second camera 282 as biometric information (step S25). The authentication part 217 performs authentication using the iris image 1 and authentication using the iris image 2 (step S26).

The authentication part 217 authenticates the target by matching an iris image as the biometric information of the target with a registered registration information. The authentication part 217 may calculate a matching score by comparing the iris image with a previously registered iris image. The matching score may refer to a value indicating the degree of match between the acquired iris image and the previously registered iris image. The matching score may also refer to a value indicating the degree of match between features extracted from the acquired iris image and previously registered features. Therefore, the authentication part 217 may calculate the matching score by matching the features extracted from the acquired iris image and the previously registered features.

The authentication part 217 determines whether iris authentication has been successful. In iris authentication, in case the matching score is greater than or equal to a predetermined threshold value, it is determined that the target is a person who has been registered in advance. The authentication part 217 may determine that iris authentication has been successful in case the matching score exceeds the predetermined threshold value. In this case, the authentication part 217 may determine that iris authentication is unsuccessful in case the matching score is less than the predetermined threshold value. In addition, in case the matching score is equal to the predetermined threshold value, it may be determined that the biometric authentication is successful or that biometric authentication is unsuccessful.

In addition, the authentication part 217 may perform face authentication using a face image in addition to the iris authentication. The authentication part 217 may perform face authentication by comparing the face image of the target included in the image captured by the camera 27 with a face image of the target that has been registered in advance. In other words, the authentication part 217 may perform multimodal authentication.

The authentication result notification part 218 notifies the authentication results to the first target T1 and the second target T2 (step S27). The authentication result notification part 218 may notify the authentication results to the target that has arrived at the endpoint E of the lane La.

A display apparatus may be provided at the endpoint E of the lane La. In this case, the authentication result notification part 218 may notify the target of the success or unsuccess of the authentication of the target by displaying information indicating the success or unsuccess of the authentication of the target on the display apparatus.

The authentication result notification part 218 may display on the display apparatus the action that the target should take depending on the success or unsuccess of the authentication. For example, the action that the target should take in case the authentication is successful may be admission to the restricted area. For example, the action that the target should take in case the authentication is unsuccessful may be to re-enter the lane La. For example, the action that the target should take in case the authentication is unsuccessful may be to undergo an examination by an examiner who will judge whether or not to admit the target to the restricted area.

For example, a gate may be provided at the endpoint E of the lane La. For example, a flap that can be opened and closed may be provided at the endpoint E of the lane La. In case the authentication of the target is successful, the authentication result notification part 218 may notify the target that the authentication was successful by opening the previously closed gate. In case the authentication of the target is unsuccessful, the authentication result notification part 218 may notify the target that the authentication is unsuccessful by closing the previously opened gate. For example, the authentication result notification part 218 may notify the target of the success or unsuccess of the authentication by illuminating feet of the target in a different color depending on the success or unsuccess of the authentication.

A security guard may be stationed at the endpoint E of the lane L. The security guard may approach the target who does not take action in accordance with the authentication result notified by the authentication result notification part 218.

### [2-3: Technical Effect]

The information processing apparatus 2 according to this disclosure emits light to the target from different directions, so it can prevent shadows from being cast on the target. In addition, the information processing apparatus 2 changes the amount of light according to the position of the target, so it can acquire the iris images of similar brightness regardless of where the target is located. Therefore, the information processing apparatus 2 can perform biometric authentication using iris images suitable for iris authentication.

### 3: Third Example Embodiment

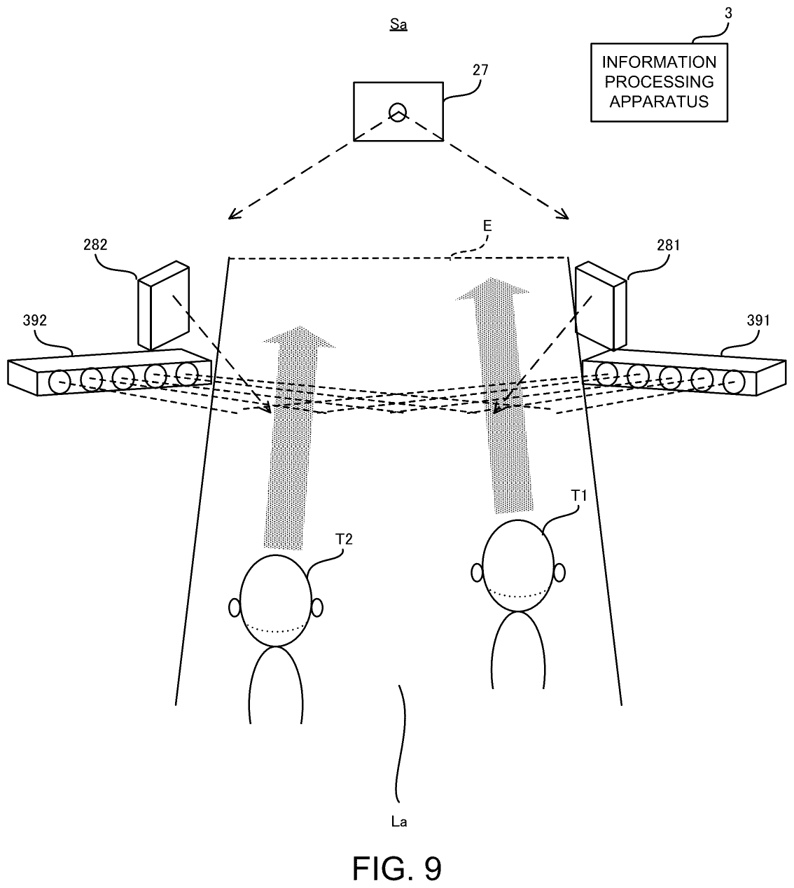

The third embodiment of the information processing apparatus, the information processing system, the information processing method, and the recording medium is explained with reference to FIG. 9 to FIG. 14B. The third embodiment of the information processing apparatus, the information processing system, the information processing method, and the recording medium is explained below using an information processing system Sa, which includes an information processing apparatus 3 according to this disclosure. For the third embodiment, explanations that overlap with the explanations of the first and second embodiments given above are omitted as appropriate. In addition, on the drawings, the parts that are common with the second embodiment are indicated with the same reference numerals.

### [3-1: Configuration of the Information Processing System Sa]

As shown in FIG. 9, the information processing system Sa includes the information processing apparatus 3, the camera 27, the first camera 281, the second camera 282, a first lighting apparatus 391, and a second lighting apparatus 392. The information processing apparatus 3 may communicate with the camera 27, the first camera 281, the second camera 282, the first lighting apparatus 391, and the second lighting apparatus 392 via the communication apparatus 23.

Each of the first lighting apparatus 391 and the second lighting apparatus 392 includes a plurality of lighting elements El arranged side by side. “Lighting element” may be a “unit” of lighting that can be controlled independently. For example, a “lighting element” may include a single light source. One “lighting element” may include a predetermined number of light sources. A light source may be, for example, a light bulb. What is referred to as a “lighting element” may be determined arbitrarily depending on the requirements to which the lighting operation is to be applied.

Each of the plurality of the lighting elements El may be able to emit light at a different position. Each of the plurality of the lighting elements El may be arranged to emit light at a different position. Each of the plurality of the lighting elements El may be arranged to emit a different position in the width direction of the lane La. In addition, in case explaining without distinguishing between the first lighting apparatus 391 and the second lighting apparatus 392, it may be referred to as a lighting apparatus 39.

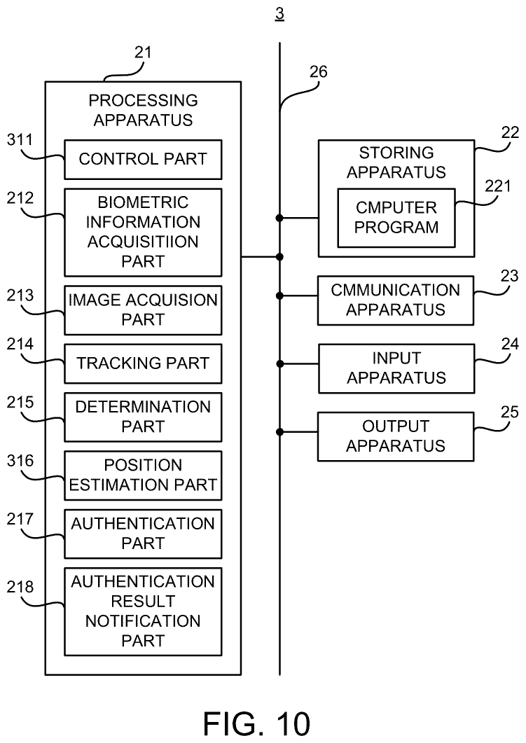

As shown in FIG. 10, the processing apparatus 21 provided by the information processing apparatus 3 may have a control part 311, the biometric information acquisition part 212, the image acquisition part 213, the tracking part 214, the determination part 215, a position estimation part 316, the authentication part 217, and the authentication result notification part 218 as function blocks that are logically realized or processing circuits that are physically realized.

[3-2: Information Processing Method Executed by the Information Processing Apparatus 3] The control part 311 may control the emission of light by each of the plurality of the lighting elements El, depending on the position of the target in the alignment direction. The control part 311 may control the lighting elements El that emits light so that it differs depending on the position of the target in the alignment direction. The target that moves on the one side of the center of the lane La is located at an one side of the alignment direction in the predetermined area PA. In addition, the target that moves on the other side of the center of the lane La is located at an other side of the alignment direction in the predetermined area PA. In other words, the control part 311 may control the lighting element El to emit light differently in case the target is moving from the center of the lane La to the one end side and in case the target is moving from the center of the lane La to the other end side.

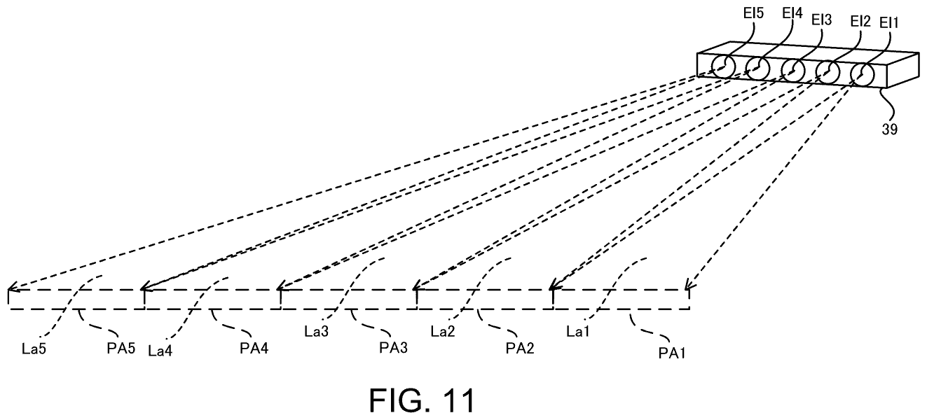

For example, the predetermined area PA may include multiple areas with different positions in the alignment direction. As shown in FIG. 11, the predetermined area PA may include five areas, for example, a predetermined area PA1, a predetermined area PA2, a predetermined area PA3, a predetermined area PA4, and a predetermined area PA5. In this case, the lighting elements El1 may emit light L1 to the predetermined area PA1. The lighting elements El2 may emit light L2 to the predetermined area PA2. The lighting elements E13 may emit light L3 to the predetermined area PA3. The lighting elements El4 may emit light L4 to the predetermined area PA4. The lighting elements E15 may emit light L5 to the predetermined area PA5.

The position estimation part 316 may estimate which of the predetermined area PA1, the predetermined area PA2, the predetermined area PA3, the predetermined area PA4, and the predetermined area PAS the position of the target is included in. In case the position of the target is estimated to be included in the predetermined area PA1, the control part 311 may control the lighting elements El1 to emit the light L1. In case the position of the target is estimated to be included in the predetermined area PA2, the control part 311 may control the lighting elements El2 to emit the light L2. In case the position of the target is estimated to be included in the predetermined area PA3, the control part 311 may control the lighting elements E13 to emit the light L3. In case the position of the target is estimated to be included in the predetermined area PA4, the control part 311 may control the lighting elements E14 to emit light L4. In case the position of the target is estimated to be included in the predetermined area PA5, the control part 311 may control the lighting elements E15 to emit light L5.

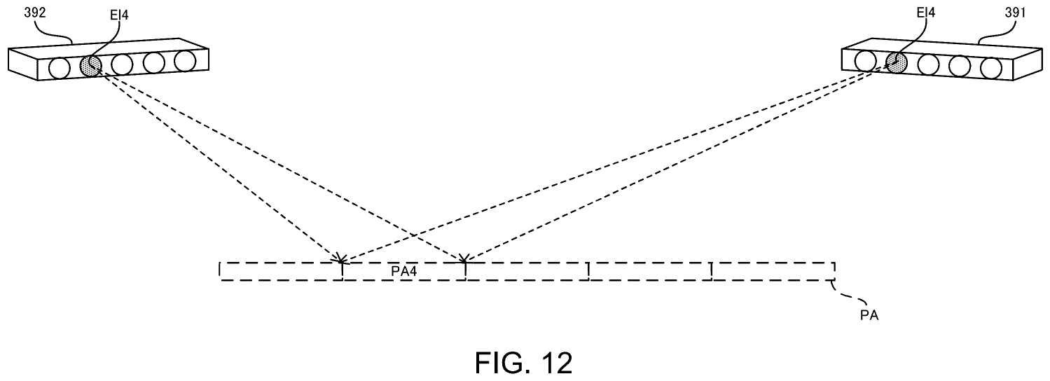

FIG. 12 shows an example in which the position of the target is estimated to be included in the predetermined area PA4, and the lighting elements E14 is emitting light L4. As shown in FIG. 12, each of the first lighting apparatus 391 and the second lighting apparatus 392 may emit light according to its position in the alignment direction.

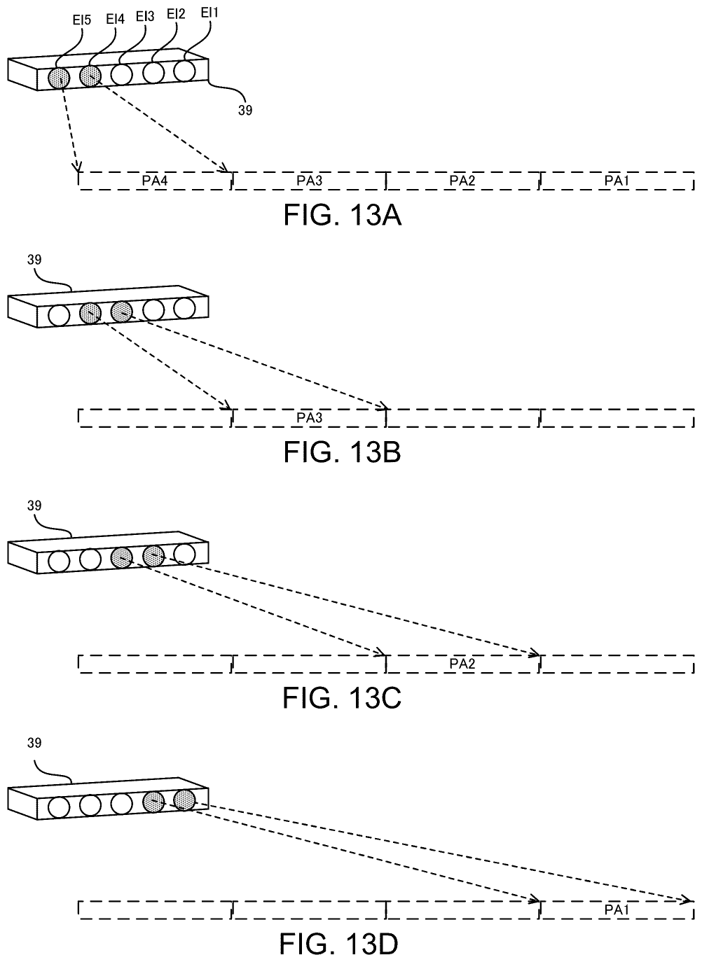

The control part 311 may control multiple adjacent lighting elements to emit light. As shown in FIG. 13A to FIG. 13D, the predetermined area PA may include four areas, for example, a predetermined area PA1, a predetermined area PA2, a predetermined area PA3, and a predetermined area PA4. In this case, the position estimation part 316 may estimate whether the position of the target is included in the predetermined area PA1, the predetermined area PA2, the predetermined area PA3, and the predetermined area PA4.

FIG. 13A shows an example where the predetermined area PA4 is emitted by the lighting elements El4 and the lighting elements E15. In case the position of the target is estimated to be included in the predetermined area PA4, the control part 311 may control the lighting elements E14 and the lighting elements E15 to emit light. FIG. 13B shows an example where the predetermined area PA3 is emitted by the lighting elements E13 and the lighting elements El4. In case the position of the target is estimated to be included in the predetermined area PA3, the control part 311 may control the lighting elements El3 and the lighting elements E14 to emit light. FIG. 13C shows an example where the predetermined area PA2 is emitted by the lighting elements El2 and the lighting elements E13. In case the position of the target is estimated to be included in the predetermined area PA2, the control part 311 may control the lighting elements El2 and the lighting elements E13 to emit light. FIG. 13D shows an example where the predetermined area PAI is emitted by the lighting elements El1 and the lighting elements El2. In case the position of the target is estimated to be included in the predetermined area PA1, the control part 311 may control the lighting elements El1 and the lighting elements El2 to emit light.

In addition, the amount of light emitted by each of the plurality of the lighting elements El may be different. For example, the control part 311 may control the light emitted by the lighting elements El1 included in the second lighting apparatus 392 to be greater than the light emitted by the lighting elements El1 included in the first lighting apparatus 391. Also, the control part 311 may control the light emitted by the lighting elements E12 included in the second lighting apparatus 392 to be greater than the light emitted by the lighting elements El2 included in the first lighting apparatus 391. Also, the control part 311 may control the light emitted by the lighting elements E14 included in the first lighting apparatus 391 to be greater than the light emitted by the lighting elements E14 included in the second lighting apparatus 392. In addition, the control part 311 may control the light emitted by the lighting elements E15 included in the first lighting apparatus 391 to be greater than the light emitted by the lighting elements E15 included in the second lighting apparatus 392. In addition, the control part 311 may control the light emitted by the lighting elements E13 included in the first lighting apparatus 391 to be the same as the light emitted by the lighting elements E13 included in the second lighting apparatus 392.

In case a plurality of the targets are moving in a line and the plurality of the targets are positioned at the predetermined area PA, for example, in case the first target is positioned at a first position and the second target is positioned at a second position, the control part 311 may cause light to be emitted on all of the plurality of the lighting elements El. In this case, each the lighting elements El may be emitted with the same amount of light. Alternatively, each the lighting elements El may be emitted with a different amount of light, depending on the position of the target.

In addition, the control part 311 may select the lighting elements El so that the shadows of the other target do not fall on the first target and the second target. For example, the control part 311 may change the elements selected in the first lighting apparatus 391 and the second lighting apparatus 392 based on the position and moving speed of the other target. In addition, the control part 311 may specify the eye position of the target located in the predetermined area PA and select the lighting elements El that emit light according to the specified eye position.

### 3-3: Modification Example 1 of the Lighting Apparatus 39

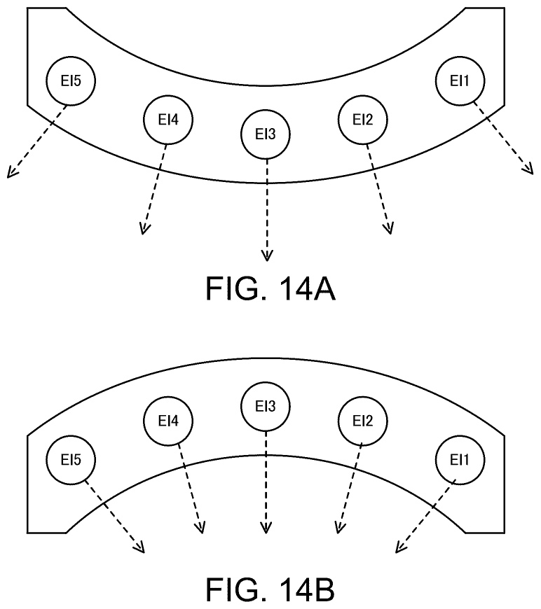

Each of the plurality of the lighting elements El may be able to emit light in a different direction. Each of the plurality of the lighting elements El may be arranged to emit light in a different direction. FIG. 14A and FIG. 14B are cross-sectional views of a modification of the lighting apparatus 39 viewed from above. As illustrated in FIG. 14A and FIG. 14B, each of the plurality of the lighting elements El may not be arranged in a straight line to emit light in a different direction. By having each of the plurality of the lighting elements El emit light in a different direction, it is possible to make the area emitted by each of the plurality of the lighting elements El more different.

In case the plurality of the lighting elements El are arranged as shown in FIG. 14A, each of the plurality of the lighting elements El may emit light on the predetermined area PA, for example, in the same way as in the case illustrated in FIG. 11. On the other hand, in case the plurality of the lighting elements El are arranged as shown in FIG. 14B, for example, the lighting element El1 may emit light on the predetermined area PAS as illustrated in FIG. 11. In addition, the lighting element E12 may emit light on the predetermined area PA4 as shown in FIG. 11. In addition, the lighting element El4 may emit light on the predetermined area PA2 as shown in FIG. 11. In addition, the lighting element E15 may emit light on the predetermined area PAI as shown in FIG. 11. The lighting element E13 may emit light on the predetermined area PA3 as shown in FIG. 11.

### 3-4: Modification Example 2 of the Lighting Apparatus 39

Each of the plurality of lighting elements may be arranged at different positions in the horizontal direction as well as at different positions in a direction different from the horizontal direction (e.g., the height direction (vertical direction)). FIG. 9 and FIG. 11 to FIG. 14B illustrate cases where the lighting apparatus 39 includes the lighting elements El arranged in the horizontal direction, but the lighting apparatus 39 may also include the lighting elements El arranged in the height direction. In this case, the control part 311 may specify a position in the height direction in addition to the position in the alignment direction of an eye of the target located in the predetermined area PA. The control part 311 may select lighting elements that emit light according to the specified the position of the eye (the position in the alignment direction and the position in the height direction).

### [3-5: Technical Effect]

The information processing apparatus 3 according to this disclosure can provide appropriate lighting according to the position of the target by controlling the lighting of each of the plurality of the lighting elements El.

### 4: Fourth Example Embodiment

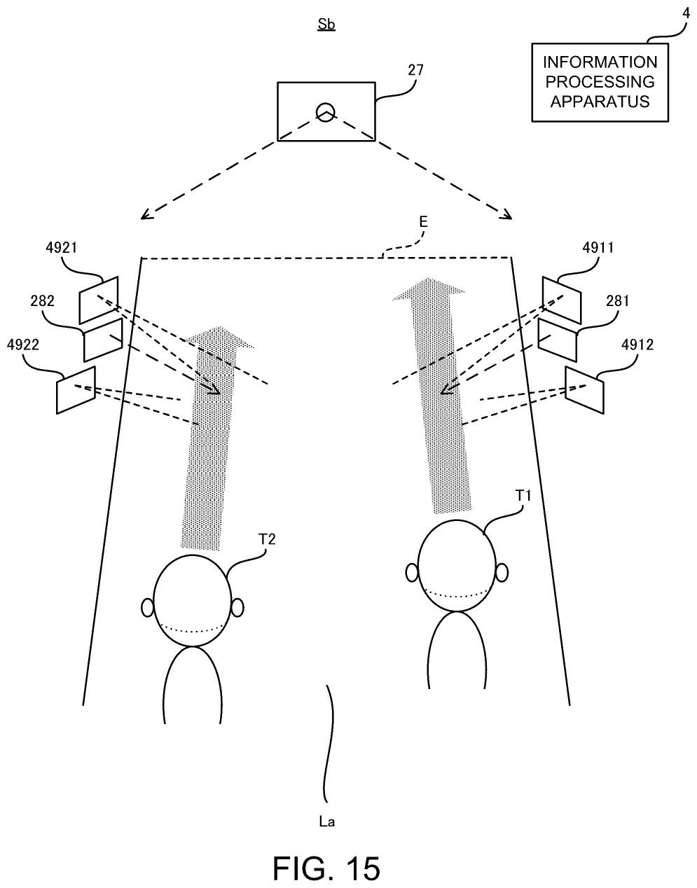

The fourth embodiment of the information processing apparatus, the information processing system, the information processing method, and the recording medium is explained with reference to FIG. 15 to FIG. 17C. The following describes the fourth embodiment of the information processing apparatus, the information processing system, the information processing method, and the recording medium using the information processing system Sb, including an information processing apparatus 4 according to this disclosure. For the fourth embodiment, explanations that overlap with the explanations of the first to third embodiments described above are omitted as appropriate. In addition, on the drawings, the same reference numerals are used to indicate the parts that are common to the second and third embodiments.

### [4-1 Configuration of the Information Processing System Sb]

The information processing system Sb has at least two the lighting apparatus in the one end of the alignment direction and at least two the lighting apparatus in the other end of the alignment direction. As shown in FIG. 15, two lighting apparatuses 4911, 4912 may be provided at the one end of the width direction of the lane La. In addition, two lighting apparatuses 4921, 4922 may be provided at the other end of the width direction of the lane La. The lighting apparatuses 4911, 4921 provided at the front of the moving direction are referred to as a front lighting apparatus 49-1, and the lighting apparatuses 4912, 4922 provided at the rear of the moving direction are referred to as a rear lighting apparatus 49-2. The information processing system Sb includes the information processing apparatus 4, the camera 27, the first camera 281, the second camera 282, and plurality of the lighting apparatuses 4911, 4912, 4921, 4922.

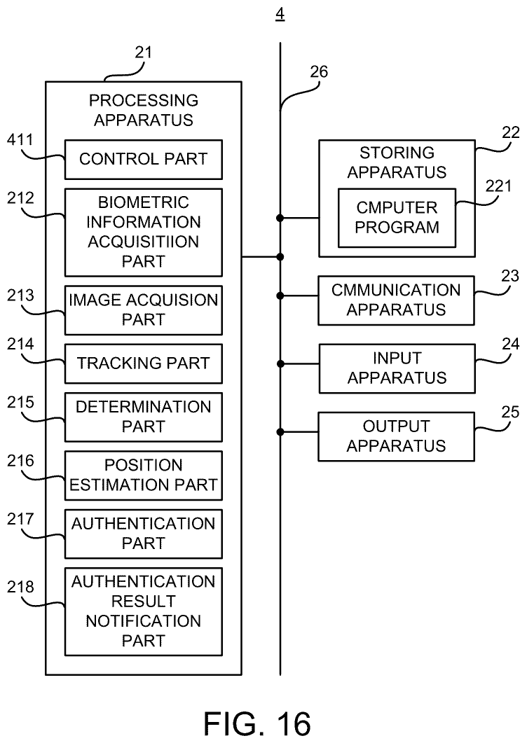

The information processing apparatus 4 may communicate with the camera 27, the first camera 281, the second camera 282, and the plurality of the lighting apparatuses 4911, 4912, 4921, 4922 via the communication apparatus 23. As shown in FIG. 16, the processing apparatus 21 provided by the information processing apparatus 4 may have a control part 411, the biometric information acquisition part 212, the image acquisition part 213, the tracking part 214, the determination part 215, the position estimation part 216, the authentication part 217, and the authentication result notification part 218 as function blocks that are logically realized or processing circuits that are physically realized.

### [4-2: Information Processing Method Executed by the Information Processing Apparatus 4]

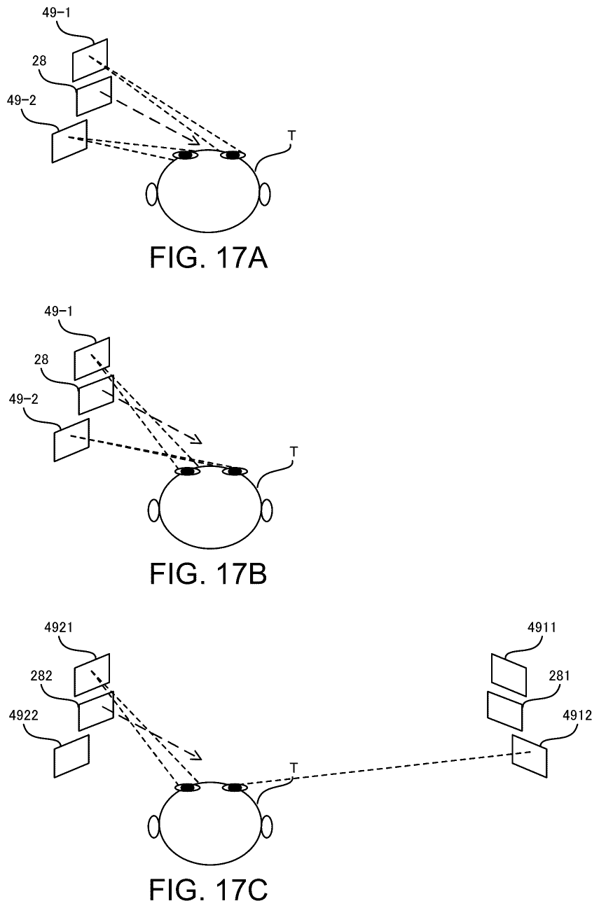

The control part 411 may control one of the front lighting apparatuses 49-1 and the rear lighting apparatuses 49-2, which are provided at the same side as the iris camera 28 that captures the target, to emit light to one of left and right eyes of the target, and the other of the front lighting apparatuses 49-1 and the rear lighting apparatuses 49-2, which are provided at the same side as the iris camera 28 that captures the target, emits light to the other of the left and right eyes of the target. As illustrated in FIG. 17A, the front lighting apparatus 49-1, which is provided at the same side as the iris camera 28 that captures the target, may emit light to the right eye of the target, and the rear lighting apparatus 49-2, which is provided at the same side as the iris camera 28 that captures the target, may emit light to the left eye of the target. Alternatively, as illustrated in FIG. 17B, the front lighting apparatus 49-1, which is provided at the same side as the iris camera 28 that captures the target, may emit light to the left eye of the target, and the rear lighting apparatus 49-2, which is provided at the same side as the iris camera 28 that captures the target, may emit light to the right eye of the target.

Alternatively, the control part 411 may control one of the front lighting apparatuses 49-1 and the rear lighting apparatus 49-2, which are provided at the same side as the iris camera 28 that captures the target, to emit light to one of the left and right eyes of the target, and one of the front lighting apparatus 49-1 and the rear lighting apparatus 49-2, which are provided at the side different from the iris camera 28 that captures the target, emits light to the other of the left and right eyes of the target. As shown in FIG. 17C, the front the lighting apparatus 4921, which is provided at the same side as the second camera 282 that captures the target, may emit light to the left eye of the target, and the rear the lighting apparatus 4912, which is provided at the side different from the second camera 282 that captures the target, may emit light to the right eye of the target. Although it is omitted from the illustration, light may be emitted on the target in a combination where the lighting apparatus 4911 emits light from one side of the target and the lighting apparatus 4921 emits light from the other side of the target. Alternatively, light may be emitted on the target using a combination of the lighting apparatus 4911 emitting light from one side of the target and the lighting apparatus 4922 emitting light from the other side of the target. Alternatively, light may be emitted on the target using a combination of the lighting apparatus 4912 emitting light from one side of the target and the lighting apparatus 4922 emitting light from the other side of the target.

In addition, at least one of the lighting apparatuses 4911, 4912, 4921, and 4922 may include a plurality of the lighting elements El arranged in a line, as in the lighting apparatus 39 in the third embodiment. In this case, the control part 411 may control the emission of light by each of the plurality of the lighting elements El, depending on the position of the target in the alignment direction.

### [4-3: Technical Effects]

The information processing apparatus 4 according to this disclosure can illuminate the target appropriately because each of the plurality of the lighting apparatus provided at a location relatively close to the target illuminates the target from a different direction. In case the information processing apparatus 4 performs biometric authentication, it can perform biometric authentication using the biometric information acquired from the target that has been illuminated appropriately.

### 5: Fifth Example Embodiment

This section describes the fifth embodiment of the information processing apparatus, the information processing system, the information processing method, and the recording medium. The information processing system of the fifth embodiment performs the information processing method described above. The information processing system of the fifth embodiment may include one or more information processing apparatuses, which are omitted from the illustration. In other embodiments, one information processing apparatus performs the information processing method described above, but in the fifth embodiment, one or more information processing apparatuses may perform the information processing method described above. In other words, each of the multiple steps included in the above-mentioned information processing method may be performed by a different information processing apparatus. For example, some of the multiple steps included in the above-mentioned information processing method may be performed by a first information processing apparatus, and the remaining steps of the multiple steps included in the above-mentioned information processing method may be performed by a second information processing apparatus.

### [6: Supplementary Notes]

With regard to the above-described embodiments, the following Supplementary Notes may also be described, but are not limited to the following.

[Supplementary Note 1]

An information processing system including:
at least one memory that is configured to store instructions; and
at least one processor that is configured to execute the instructions to:
control lighting apparatuses to emit light in at least one of the following modes: a first mode in which light is emitted to at least a first target in case the first target is located in a predetermined area; and a second mode in which light is emitted at least to a second target in case the second target is located in the predetermined area; and
acquire at least one of biometric information of the first target to which light is emitted by the lighting apparatuses and biometric information of the second target to which light is emitted by the lighting apparatuses.

### [Supplementary Note 2]

The information processing system according to Supplementary Note 1, wherein a first position of the first target in case of the first target is located in the predetermined area, and a second position of the second target in case of the second target is located in the predetermined area, are different positions in an alignment direction that is different from a moving direction of the first target and the second target.

### [Supplementary Note 3]

The information processing system according to Supplementary Note 2, wherein one of the lighting apparatuses are provided at one end of the alignment direction and other of the lighting apparatuses are provided at other end of the alignment direction in a moving area where the first target and the second target move.

[Supplementary Note 4]

The information processing system according to claim 3, wherein the at least one processor is configured to execute the instructions to:
control the lighting apparatuses so that the light emitted by the other of the lighting apparatuses is greater than the light emitted by the one of the lighting apparatuses in case a target is moving on one side of center of a direction different from the moving direction in the moving area; and
control the lighting apparatuses so that the light emitted by the one of the lighting apparatuses is greater than the light emitted by the other of the lighting apparatuses in case of a target is moving on other side of the center of the direction different from the moving direction in the moving area.

### [Supplementary Note 5]

The information processing system according to Supplementary Note 2, wherein the lighting apparatuses includes a plurality of lighting elements arranged in a line, and
the at least one processor is configured to execute the instructions to control light emission by each of the plurality of lighting elements according to a position of a target in the alignment direction.

### [Supplementary Note 6]

The information processing system according to Supplementary Note 5, wherein the at least one processor is configured to execute the instructions to control the light emission by all of the plurality of lighting elements, in case the second target is located at the second position when the first target is located at the first position.

### [Supplementary Note 7]

The information processing system according to Supplementary Note 2, further including at least two one side lighting apparatuses provided at one end of the alignment direction,
wherein the at least one processor is configured to execute the instructions to control a first lighting apparatus of the at least two one side lighting apparatuses to emit light to a right eye of a target; and control a second lighting apparatus of the at least two one side lighting apparatuses to emit light to a left eye of the target, in case the target is located on one side of center of the alignment direction,
further including at least two other side lighting apparatuses provided at other end of the alignment direction,
wherein the at least one processor is configured to execute the instructions to control a first lighting apparatus of the at least two other side lighting apparatuses to emit light to the right eye of the target; and control a second lighting apparatus of the at least two other side lighting apparatuses to emit light to the left eye of the target, in case the target is located on other side of the center in the alignment direction.

### [Supplementary Note 8]

An information processing method including:
controlling lighting apparatuses to emit light in at least one of the following modes: a first mode in which light is emitted to at least a first target in case the first target is located in a predetermined area; and a second mode in which light is emitted at least to a second target in case the second target is located in the predetermined area; and
acquiring at least one of biometric information of the first target to which light is emitted by the lighting apparatuses and biometric information of the second target to which light is emitted by the lighting apparatuses.

### [Supplementary Note 9]

A non-transitory recording medium on which a computer program that allows a computer to execute the information processing method according to claim 8 is recorded.

The present disclosure is not limited to the above-described examples and is allowed to be changed, if desired, without departing from the essence or spirit of the invention which can be read from the claims and the entire specification. A base-station slave apparatus, an information processing method, and a non-transitory recording medium with such changes, are also included in the technical concepts of the present disclosure.

### DESCRIPTION OF REFERENCE NUMERALS

1,2,3,4 information processing apparatus
S information processing system
11, 211, 311, 411 control part
12 acquisition part
212 biometric information acquisition part
213 image acquisition part
214 tracking part
215 determination part
216, 316 position estimation part
217 authentication part
218 authentication result notification part
27 camera
281 first camera
282 second camera
291, 391 first lighting apparatus
292, 392 second lighting apparatus
49-1 front lighting apparatus
49-2 rear lighting apparatus

What is claimed is:

1. An information processing system comprising:
at least one memory that is configured to store instructions; and
at least one processor that is configured to execute the instructions to:
control lighting apparatuses to emit light in at least one of the following modes: a first mode in which light is emitted to at least a first target in case the first target is located in a predetermined area; and a second mode in which light is emitted at least to a second target in case the second target is located in the predetermined area; and
acquire at least one of biometric information of the first target to which light is emitted by the lighting apparatuses and biometric information of the second target to which light is emitted by the lighting apparatuses.

2. The information processing system according to claim 1, wherein a first position of the first target in case of the first target is located in the predetermined area, and a second position of the second target in case of the second target is located in the predetermined area, are different positions in an alignment direction that is different from a moving direction of the first target and the second target.

3. The information processing system according to claim 2, wherein one of the lighting apparatuses are provided at one end of the alignment direction and other of the lighting apparatuses are provided at other end of the alignment direction in a moving area where the first target and the second target move.

4. The information processing system according to claim 3, wherein the at least one processor is configured to execute the instructions to:
control the lighting apparatuses so that the light emitted by the other of the lighting apparatuses is greater than the light emitted by the one of the lighting apparatuses in case a target is moving on one side of center of a direction different from the moving direction in the moving area; and
control the lighting apparatuses so that the light emitted by the one of the lighting apparatuses is greater than the light emitted by the other of the lighting apparatuses in case of a target is moving on other side of the center of the direction different from the moving direction in the moving area.

5. The information processing system according to claim 2, wherein the lighting apparatuses includes a plurality of lighting elements arranged in a line, and
the at least one processor is configured to execute the instructions to control light emission by each of the plurality of lighting elements according to a position of a target in the alignment direction.

6. The information processing system according to claim 5, wherein the at least one processor is configured to execute the instructions to control the light emission by all of the plurality of lighting elements, in case the second target is located at the second position when the first target is located at the first position.

7. The information processing system according to claim 2, further comprising at least two one side lighting apparatuses provided at one end of the alignment direction,
wherein the at least one processor is configured to execute the instructions to control a first lighting apparatus of the at least two one side lighting apparatuses to emit light to a right eye of a target; and control a second lighting apparatus of the at least two one side lighting apparatuses to emit light to a left eye of the target, in case the target is located on one side of center of the alignment direction,
further comprising at least two other side lighting apparatuses provided at other end of the alignment direction,
wherein the at least one processor is configured to execute the instructions to control a first lighting apparatus of the at least two other side lighting apparatuses to emit light to the right eye of the target; and control a second lighting apparatus of the at least two other side lighting apparatuses to emit light to the left eye of the target, in case the target is located on other side of the center in the alignment direction.

8. An information processing method comprising:
controlling lighting apparatuses to emit light in at least one of the following modes: a first mode in which light is emitted to at least a first target in case the first target is located in a predetermined area; and a second mode in which light is emitted at least to a second target in case the second target is located in the predetermined area; and
acquiring at least one of biometric information of the first target to which light is emitted by the lighting apparatuses and biometric information of the second target to which light is emitted by the lighting apparatuses.

9. A non-transitory recording medium on which a computer program that allows a computer to execute the information processing method according to claim 8 is recorded.
